(19) United States
(12) Patent Application Publication
(10) Pub. No.: US 2003/0029278 A1
(43) Pub. Date: Feb. 13, 2003

(54) Integral hammer damper and method

(76) Inventors: Paul J. Macioce, Plymouth, MI (US); Lixin Jiang, Westland, MI (US)

Correspondence Address: HARNESS, DICKEY & PIERCE, P.L.C., P.O. BOX 828, BLOOMFIELD HILLS, MI, 48303, US

(21) Appl. No.: 09/925,775

(22) Filed: Aug. 9, 2001

(51) Int. Cl. B25D 1/12

(52) U.S. Cl. 81/22

(57) ABSTRACT

A hammer has an impact head, a handle and an elastomeric grip cover. The free end of the grip cover includes a tuned vibration absorber. In one design, the tuned vibration absorber is integral with the grip cover and may or may not include a higher density mass portion. In other designs, a mass is located within a pocket formed in the grip cover. The pocket may be open or closed.

### FIELD OF THE INVENTION

The present invention relates to vibration control for an impact implement. More particularly, the present invention relates to vibration control for an impact element in the form of an integral damper formed in the grip cover of the implement.

### BACKGROUND OF THE INVENTION

An impact hammer typically includes a head for impacting an object and a handle connected to the head. The handle is commonly formed from wood, steel or fiber reinforced composite material. A rubber or elastomeric grip usually covers the handle for improved gripping and comfort purposes. The vibration of the hammer felt by the user after impacting an object includes an initial shock and a subsequent residual vibration. The initial shock is a function of the impact force, and it usually lasts a short time, typically less than 20 ms. The residual vibration is determined by the structural dynamics of the hammer. Particularly, the damping level of the hammer mainly determines the delay time for the residual vibration. For example, the residual vibration can last over 100 ms when the hammer has low structural damping. The residual vibration is harmful in that it can result in fatigue of the user.

Non-wood handles such as steel and fiber reinforced plastic are advantageous over wood handles because of their durability, especially in an overstrike condition. However, one disadvantage of a non-wood handle is the amount of vibration these handles transmit to the hand and arm of the user. The vibration is high in non-wood handles since the damping properties of these materials can be one hundred to one thousand times less than a comparable wood handle. As a result, vibration in the non-wood handles is high and, with extensive use, may result in fatigue of the arm and hand muscles of the user. This can affect the comfort and productivity of the user. In extreme cases of implement multiple use, physiological damage can occur in the hand/arm/shoulder of the user.

Several techniques for increasing damping in hand operated impact implements have been developed in the prior art. One technique has addressed vibration control by incorporating a compliant handle and a flexible grip to provide mechanical isolation of the vibration transmitted from the implement to the user. However, design of an effective isolation system requires introducing so much compliance between the hand and the implement so as to diminish the user's ability to effectively control the implement. These designs also suffer from the disadvantages of complexity of design, high cost of manufacturing and low durability of the hand operated impact implement.

Another technique for controlling vibration in hand operated implements has been to reduce the shock of impact before it enters the handle. This can be accomplished by an implement head which is shock mounted or isolated from its handle. However, these implements suffer from the disadvantage of potential for wear which in turn causes poor durability.

Still another technique for altering the vibration in hand impact implements is to move the center of percussion by adding a mass to the handle. However, these implements suffer from the disadvantage that they are limited in their ability to reduce vibration since they do not provide increased vibration damping.

Another technique for controlling vibration in hand operated impact elements is to address damping relative to the head of the impact element. Various designs utilize a pocket in the head, typically filled with wood and/or an elastomer to dissipate vibrations in the impact element's head. However, these impact elements, while having a positive effect on the claw fracture (of a hammer) and the head vibration, are not effective on the overall impact element head/handle vibration.

Another technique which addresses impact implement vibration control uses a mushroom-shaped vibration damper for controlling impact implement vibration. The mushroom-shaped damper is made from a uniform elastomer and it can be applied internally and externally to an impact implement handle. The mushroom-shaped damper functions by having an elastomeric stem which provides a stiffness and damping element and an elastomeric cap which acts as a mass element. By its design, the cap motion causes bending in the stem which decreases the rate of delay of vibration set up in the implement by the impact. However, one disadvantage of this technique, when it is placed externally on the implement as an add-on device, is poor durability, especially in the application to hand operated impact implements. For example, the mushroom shaped damper will easily get knocked off due to the inherent rough use of hand operated impact implements. Another disadvantage of this technique is that the device must be bonded onto the hand operated impact implement adding complexity and cost to the manufacturing process.

Yet another technique is a tuned vibration absorber having a mass and an elastomeric element installed on the handle of a hand operated impact element. An optimized tuned vibration absorber of this design effectively reduces the residual vibration of the hand operated impact implement. This style of damper is an add-on device to the impact implement. However, the implementation of this type of damper can complicate the design and fabrication of the hammer and it must be qualified to meet all durability requirements, thus increasing the manufacturing costs and restricting its application.

Thus, there is a need in the art for reducing vibration in hand operated impact implements which provides the benefits of small packaging space, low manufacturing complexity, low cost, high durability, and high levels of vibration damping of the overall handle/head configuration.

### SUMMARY OF THE INVENTION

The present invention provides the art with a vibration damper integrated into the hammer grip overmolding process itself. This design requires minimal design changes and it is inexpensive to fabricate. Inherently, the design is more durable because it is integral to the grip, and it utilizes the same environmentally resistant materials used for typical molded grips. The present invention can be made to meet the required performance and durability at a very low cost with the additional feature of being visible to the user thus adding marketing value to an implement equipped with this device.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side elevation view, partially in cross-section of a hammer having an integral damper in accordance with the present invention;

FIG. 1A is an end view of the hammer shown in FIG. 1A;

FIG. 2 is a side elevation view, partially in cross-section, of a hammer having an integral damper in accordance with another embodiment of the present invention;

FIG. 2A is an end view of the hammer shown in FIG. 2A;

FIG. 3 is a side elevation view, partially in cross-section of a hammer having an integral damper in accordance with another embodiment of the present invention;

FIG. 3A is an end view of the hammer shown in FIG. 3A;

FIG. 4 is a side elevation view, partially in cross-section of a hammer having an integral damper in accordance with another embodiment of the present invention;

FIG. 4A is an end view of the hammer shown in FIG. 4A;

FIG. 5 is a side elevation view, partially in cross-section of a hammer having an integral damper in accordance with another embodiment of the present invention;

FIG. 6 is a side elevation view, partially in cross-section of a hammer having a tuned cantilever beam on the end of the handle using surrounding grip material for damping;

FIG. 6A is an end view of the hammer shown in FIG. 6; and

FIG. 7 is a side elevation view, partially in cross-section of a hammer using a tuned cantilever beam that is cut into the handle where a portion of the space is filled with grip material to provide sufficient damping.

### DETAILED DESCRIPTION OF THE PREFERRED EMBODIMENTS

The following description of the preferred embodiment(s) is merely exemplary in nature and is in no way intended to limit the invention, its application, or uses. In the embodiments offered below, common elements to the present invention include a mass element connected to the implement via a spring element tuned to oscillate at a frequency coinciding with the bending modes of the implement. Furthermore, the mass and spring elements are integral to the implement, formed either as part of the grip molding process using the same material as the grip or a secondary material either insert molded or co-molded. Alternatively, the present invention could include a mass and spring element built into the handle of the implement itself.

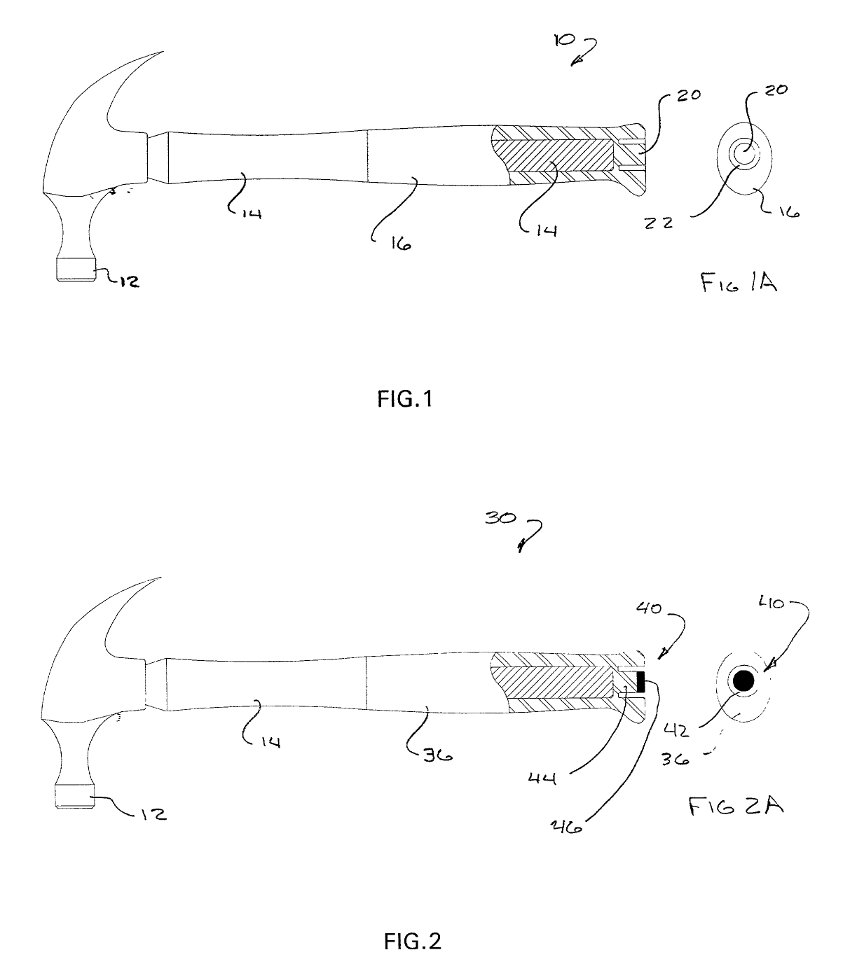

Referring now to the drawings in which like reference numerals designate like or corresponding parts throughout the several views, there is shown in FIGS. 1 and 1A an impact implement in the form of a claw hammer and which is designated generally by the reference numeral 10. Hammer 10 includes an impact end or head 12, a handle 14 and a grip cover 16. Head 12 is typically made from steel and it is attached by methods known in the art to handle 14. Handle 14 is made from a non-wood material such as steel, fiberglass or graphite-fiber composite and handle 14 extends between head 12 and grip cover 16. The present invention is most suited towards hammer 10 having metal or composite handle 14 because these handles are found to exhibit the highest levels of unwanted vibration. However, the present invention can also be extended to wood handle hammers that utilize an over-mold grip. Grip cover 16 is made from an elastomeric material such as rubber and it is attached to the end of handle 14 opposite to head 12. Grip cover 16 provides a grip for the user of hammer 10. It should be appreciated that claw hammer 10 is being illustrated as an example of a hand operated impact implement and that the present invention is applicable to other hand operated impact implements, including but not limited to, hammers, ball pein hammers, sledge hammers, dead blow hammers, axes, hatchets, picks, drywall hammers, masonry hammers and the like.

During impact of head 12 with an object, the amount of vibration felt at grip cover 16 is a function of the impact force, the mass, the stiffness of handle 14 and the damping characteristics of hammer 10. The energy imparted to the user is a combination of the initial force impulse from impact and the residual vibration resulting from resonances of head 12 and handle 14. The first bending resonance in the direction of a typical impact is the most critical for the residual vibration felt at the outside end of handle 14. The highest amplitude of this vibration response tends to occur at anti-node locations for the first bending mode, which for the case of hammer 10 occurs at head 12, the outside end of handle 14 and in a mid-position along handle 14. Without the presence of high levels of internal damping of hammer 10, the residual vibration of the first bending mode is easily transferred to the user's hand via grip cover 16. Hammer 10 is designed with a tuned vibration absorber 20 that functions to damp the vibration at grip cover 16 and thus provide a more comfortable hammer which reduces the fatigue of the user.

Tuned vibration absorber 20 is designed as an integral part of grip cover 16. Grip cover 16 defines a circular groove 22 which defines vibration absorber 20. Tuned vibration absorber 20 is an auxiliary vibrating mass which is tuned to vibrate at the bending resonance frequencies of hammer 10. The integral construction of vibration absorber 20 eliminates any need for adding additional components to grip cover 16 or hammer 10 as well as eliminating any protrusion of vibration absorber 20 beyond the end of grip cover 16. By not having tuned vibration absorber 20 extending beyond grip cover 16, and because vibration absorber 20 is integral to hammer 10, any chance of tuned vibration absorber 20 being inadvertently damaged and/or knocked off during use of hammer 10 are eliminated.

Referring now to FIGS. 2 and 2A, a hammer 30 in accordance with another embodiment of the present invention is illustrated. Hammer 30 comprises head 12, handle 14 and a grip cover 36. Grip cover 36 includes a tuned vibration absorber 40 that is defined by a circular groove 42. Tuned vibration absorber 40 is an auxiliary vibrating mass that is tuned to vibrate at the bending resonance frequencies of hammer 30. Tuned vibration absorber 40 includes a portion 44 which is integral with grip cover 36 and a mass 46 which is secured to portion 44. Mass 46 is made of any material with high density properties such as a metal component, or metal-filled, injection moldable material. For a wood handle hammer, it would be necessary to bore out a cavity at the end of handle 14 to allow for the damping device of FIGS. 1, 1A or FIGS. 2, 2A to be injection molded when the grip material was applied, and portion 44 that is integral with grip cover 36 is made of the same elastomeric material as grip cover 36. Using a relatively high density material such as tungsten, brass or steel for mass 46 allows for better tuned vibration absorber performance in a given package space. If mass 46 were made of a relatively low density material, it would require a larger volume of material to achieve the same mass as the one made using tungsten, brass or steel. Even though tuned vibration absorber 40 utilizes mass 46, it is still designed to eliminate any protrusions beyond the end of grip cover 36. By not having tuned vibration absorber 40 extend beyond grip cover 36 and by being integral to hammer 30, any chance of tuned vibration absorber 40 being inadvertently knocked off during use of hammer 30 is eliminated.

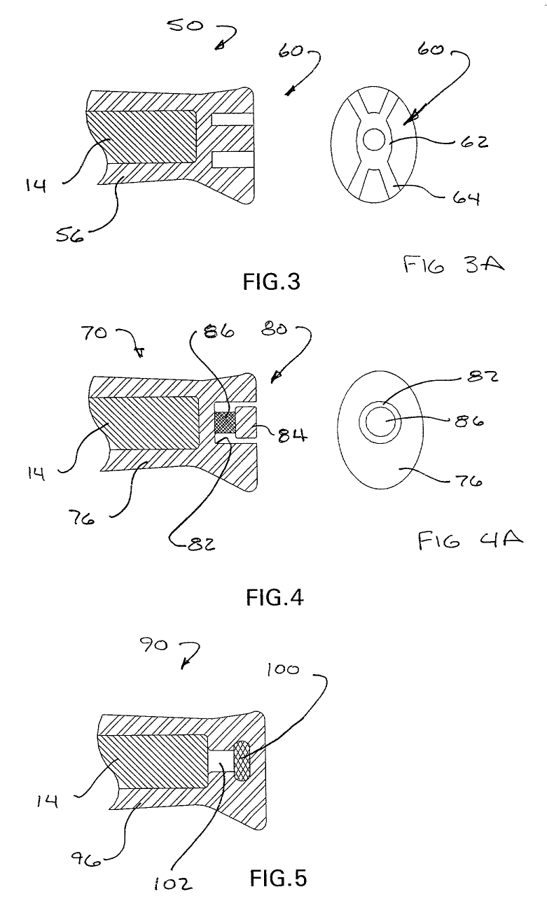

Referring now to FIGS. 3 and 3A, the grip end of a hammer 50 in accordance with another embodiment of the present invention is illustrated. Hammer 50 comprises head 12, handle 14 and a grip cover 56. Grip cover 56 includes an integral tuned vibration absorber 60 which is defined by a combination of a circular groove 62 and an X-shaped groove 64. Tuned vibration absorber 60 is an auxiliary vibrating mass that is tuned to vibrate at the bending resonance frequencies of hammer 50. By incorporating plural absorbers because of the design for grooves 62 and 64, each individual component created by grooves 62 and 64 can be tuned to a slightly different frequency range to provide a broader range of effectiveness. The integral construction of tuned vibration absorber 60 eliminates any need for adding additional components to grip cover 56 or hammer 50 as well as eliminating any protrusion of vibration absorber 60 beyond the end of grip cover 56. By not having tuned vibration absorber 60 extend beyond grip cover 56 and by being integral to hammer 50, any chance of tuned vibration absorber 60 being inadvertently damaged and/or knocked off during use of hammer 50 are eliminated. The incorporation of circular groove 62 with X-shaped groove 64 increases the mass available for tuned vibration absorber 60.

Referring now to FIGS. 4 and 4A, the grip end of a hammer 70 in accordance with another embodiment of the present invention is illustrated. Hammer 70 comprises head 12, handle 14 and a grip cover 76. Grip cover 76 includes a tuned vibration absorber 80 which is located within a pocket 82 defined by grip cover 76. Tuned vibration absorber 80 is an auxiliary vibrating mass that is tuned to vibrate at the bending resonance frequencies of hammer 70. Tuned vibration absorber 80 includes a mass 84 attached to a spring 86 which is secured to grip cover 76 at the bottom of pocket 82. Mass 84 is made from the same elastomeric material as grip cover 76. A two-shot molding process can be utilized for manufacturing grip cover 76 in which spring 86 can be made from a material of differing stiffness than grip cover 76. Mass 84 can be made of a high density material such as tungsten, brass or steel. Using a relatively high density material such as tungsten, brass or steel for mass 84 allows for better tuned vibration absorber performance in a given space. If mass 84 were made of a relatively low density material, it would require a larger volume of material to achieve the same mass as the one made using tungsten, brass or steel. Even though tuned vibration absorber 80 utilizes mass 84, it is still designed to eliminate any protrusions beyond the end of grip cover 76. By not having tuned vibration absorber 80 extend beyond grip cover 76 and by being integral to hammer 70, any chance of tuned vibration absorber 80 being inadvertently knocked off during use of hammer 70 is eliminated.

Referring now to FIG. 5, the grip end of a hammer 90 in accordance with another embodiment of the present invention is illustrated. Hammer 90 comprises head 12, handle 14 and a grip cover 96. Grip cover 96 includes a tuned vibration absorber or mass 100 that is disposed within an internal pocket 102 formed in grip cover 96. A two-shot molding process can be used to manufacture grip cover 96 whereby tuned vibration absorber 100 is made from a high density material. Tuned vibration absorber 100 is an auxiliary vibrating mass that is tuned to vibrate at the bending resonance frequencies of hammer 90. Tuned vibration absorber 100 can also be made by insert molding a mass into grip cover 96 using a high density material such as tungsten, brass or steel. Using a relatively high density material such as tungsten, brass or steel for absorber 100 allows for better tuned vibration absorber performance in a given packaging space. If absorber 100 were made of a relatively low density material, it would require a larger volume of material to achieve the same mass as the one made using brass or steel. Even though tuned vibration absorber 100 is not manufactured from the same material as grip cover 96, by being molded within internal pocket 102, absorber 100 eliminates any protrusions beyond the end of grip cover 96. By not having tuned vibration absorber 100 extend beyond grip cover 96 and by being integral to hammer 90, any chance of tuned vibration absorber 100 being inadvertently knocked off during use of hammer 90 is eliminated.

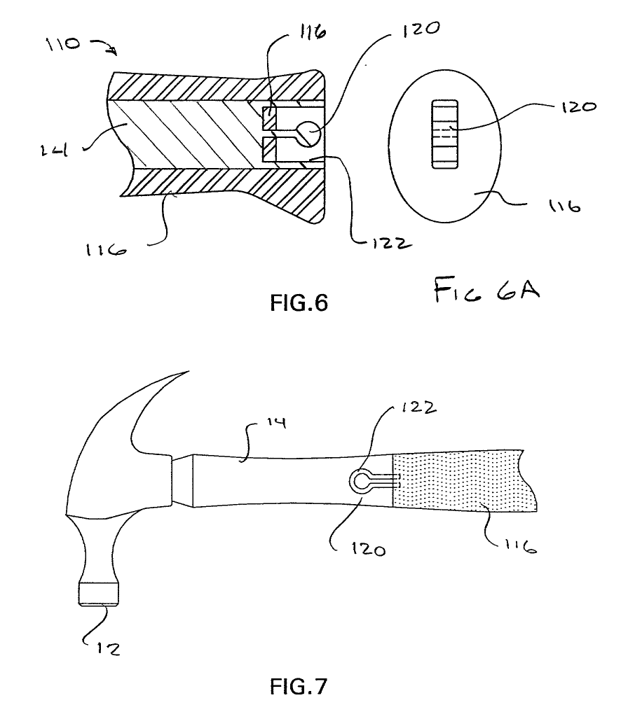

Referring now to FIG. 6, the grip of a hammer 110 in accordance with another embodiment of the present invention is illustrated. Hammer 110 comprises head 12, handle 14 and a grip cover 116. Handle 14 includes a tuned vibration absorber 120 that is disposed within a pocket 122 formed in handle 14. This design is most suitable for a forged metal or a metal I-beam style of handle 14. Over-molded grip cover 116 is located in such a manner as to be deformed when tuned vibration absorber 120 of handle 14 is subject to resonant vibration, thus providing additional damping to the single degree of freedom device. FIG. 6 illustrates tuned vibration absorber 120 in the form of a cantilever beam at the end of handle 14 covered with the ergonomically shaped grip cover 116.

Referring now to FIG. 7, a hammer 110′ in accordance with another embodiment of the present invention is illustrated. Hammer 110′ is the same as hammer 110 with the exception that tuned vibration absorber 120 is incorporated at the midpoint of handle 14 instead of at its end as shown in FIG. 6.

The various embodiments described above provide an internal or integral vibration control for a hammer. The unique design of these embodiments eliminates the need to significantly redesign the grip cover for the hammer, thus eliminating any additional manufacturing costs. The designs significantly increase the durability of a hammer incorporating a tuned vibration absorber.

The embodiments for the tuned vibration damper shown above involve the use of cantilevered dampers, but the scope of this invention is not limited to this form of damper. Many other possible embodiments exist which possess the necessary requirements of this invention: a mass element supported on a spring element with a sufficient level of damping present, and tuned to the fundamental hammer mode frequency in order to counteract unwanted vibration due to typical impacts. Furthermore, the device is incorporated into the existing grip over-molding process or handle design so as to make the cost of this robust device minimal and highly manufacturable.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An impact element having vibration damping, said impact implement comprising:
a head for impacting an object;
a handle attached to said head;
a grip cover attached to said handle;
a tuned vibration absorber attached to said grip cover to reduce overall vibration of said impact element after impacting an object.

2. The impact element of claim 1, wherein said tuned vibration absorber is integral with said grip cover.

3. The impact element of claim 1, wherein said tuned vibration absorber is integral with said grip cover, said grip cover defining a groove which forms said tuned vibration absorber.

4. The impact element of claim 3, wherein said groove includes a generally circular groove.

5. The impact element of claim 4, wherein said groove includes a generally X-shaped groove.

6. The impact element of claim 3, wherein said groove includes a generally X-shaped groove.

7. The impact element of claim 1, wherein said tuned vibration absorber includes a portion integral with said grip cover and a mass having a density greater than a density of said grip cover.

8. The impact element of claim 7, wherein said grip cover defines a groove which forms said portion of said tuned vibration absorber.

9. The impact element of claim 1, wherein said tuned vibration absorber includes a mass disposed within a pocket defined by said grip cover, said mass having a density greater than a density of said grip cover.

10. The impact element of claim 9, wherein said tuned vibration absorber further includes an elastomeric portion attached to said mass.

11. The impact element of claim 10, wherein said elastomeric portion and said grip cover are made from the same material.

12. The impact element of claim 9, wherein said pocket is a closed pocket.

13. An impact implement having vibration damping, said impact implement comprising:
a head for impacting an object;
a handle attached to said head;
a grip cover attached to said handle, said grip cover defining a free end; and
a groove formed into said free end of said grip cover to form a tuned vibration absorber.

14. The impact element of claim 13, wherein said groove includes a generally circular groove.

15. The impact element of claim 14, wherein said groove includes a generally X-shaped groove.

16. The impact element of claim 13, wherein said groove includes a generally X-shaped groove.

17. The impact element of claim 13, further comprising a mass attached to said tuned vibration absorber.

18. An impact element having vibration damping, said impact element comprising:
a head for impacting an object;
a handle attached to said head;
a grip cover attached to said handle, said grip cover defining a pocket;
a mass disposed within said pocket to form a tuned vibration absorber, said mass having a density greater than a density of said grip cover.

19. The impact element of claim 18, wherein said tuned vibration absorber further includes an elastomeric portion attached to said mass.

20. The impact element of claim 19, wherein said elastomeric portion and said grip cover are made from the same material.

21. The impact element of claim 18, wherein said pocket is a closed pocket.
